(19) United States
(12) Patent Application Publication
(10) Pub. No.: US 2021/0151270 A1
(43) Pub. Date: May 20, 2021

(54) REMOTE SHUT DOWN DEVICE

(71) Applicant: King Spellins Engineering, LLC, Katy, TX (US)

(72) Inventors: Jeffrey D. King, Katy, TX (US); Ronald A. Spellins, Katy, TX (US)

(21) Appl. No.: 16/690,079

(22) Filed: Nov. 20, 2019

(51) Int. Cl. H01H 47/22; H04W 4/14; H04W 4/20

(52) U.S. Cl. CPC H01H 47/22; H04W 4/20; H04W 4/14

(57) ABSTRACT

A method and apparatus for remotely controlling operational characteristics of an electrical device or machine by using a processor mounted on the machine that receives control messages from a remotely located system that allow the processor to turn the electrical device or machine off by discontinuing electrical power to the electrical machine or device.

### BACKGROUND OF THE INVENTION

In various industries, leasing of equipment to reduce upfront capital expenditures is a financially attractive option. In the food service industry, for example, leasing of equipment such as commercial ice machines, frozen drink machines, soft serve ice cream machines, and other food service equipment is a common practice due to the high acquisition cost of the equipment in a purchase scenario. As such, various industries, including the food service industry, heavily rely upon leasing options to acquire equipment. However, leasing of expensive equipment to financially risky businesses, such as restaurants, creates challenges for the lease holders. The restaurant owner who often times is financially strained has possession of the leased equipment and neglects to make timely payments to the leaseholder. This creates a significant cost challenges for the leaseholder in continually having to seek collection of lease payments for equipment that should be made on a regular interval prescribed by the lease agreement.

As such, there is a need for a method and/or apparatus configured to help leaseholders maintain operational control over lease equipment so that the leaseholders may selectively disable the leased equipment in situations where the lessee has not complied with the terms of the lease agreement, such as when the lessee has not made a timely payment for the leased equipment.

### SUMMARY OF THE INVENTION

The present disclosure generally provides a method and apparatus for remotely controlling certain operational characteristics of a piece of electric equipment. More particularly, the present invention provides a module that may be added to electric equipment that allows for remote disabling of the equipment.

The present disclosure further provides a system for remotely controlling power relays in a machine, wherein the system includes an electronic controller in communication with a source of electrical power, the electronic controller having a microprocessor based processing unit, a nonvolatile memory device in bidirectional electrical communication with the processing unit, and a cellular communication module in bidirectional communication with the processing unit. The system further includes an electrical contact relay in electrical communication with the source of electrical power and one or more components of a machine being controlled, the electrical contact relay having a control input that determines an open or closed state of the electrical contact relay, the control input being in communication with an output of the processing unit.

The present disclosure may further provide a system for remotely controlling electrical power supplied to an electrical component where an electronic controller is in communication with a source of electrical power, the electronic controller including a processing module, a wireless communication module connected to the processing module, and a selectively actuated electrical switch in communication with and controlled by the processing module. The system operates so that the processing module receives control instructions from a remote master controller, the control instructions being transmitted wirelessly from the remote master controller to the processing module via the wireless communication module, the control instructions being processed by the processing module to generate a corresponding change of state instruction that is communicated to the selectively actuated electrical switch, the selectively actuated electrical switch then open or closes an electrical flow path corresponding to the change of state instruction.

The present disclosure further provides a method for remotely shutting down an electrical machine. The method includes receiving a control message in a communication interface of a control system mounted in electrical communication with the electrical machine, validating the control signal by comparing a text or numerical sequence associated with the control message, and upon validating, processing the control message in a processor module of the control system to generate a change state instruction. The method further includes sending the change in state instruction to a power relay or selectively actuated electrical switch in communication with a power source of the electrical machine, the change in state instruction causing the power relay or selectively actuated electrical switch to open circuit so that electrical power is no longer provided to the electrical machine.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings. It is to be noted, however, that the appended drawings illustrate only typical embodiments of this disclosure and are therefore not to be considered limiting of its scope, for the invention may admit to other equally effective embodiments.

FIG. 1 illustrates a high-level schematic of an exemplary system of the disclosure;

FIG. 2 illustrates a schematic view of a more detailed embodiment of an exemplary system of the disclosure; and

FIG. 3 is a flowchart illustrating an exemplary method of the disclosure.

### DETAILED DESCRIPTION OF THE PREFERRED EMBODIMENTS

It is to be understood that the following disclosure describes several exemplary embodiments for implementing different features, structures, or functions of the present invention. Exemplary embodiments of components, arrangements, electronic modules, methods, and configurations are described below to explain the structure, function, and capabilities of the present disclosure; however, these exemplary embodiments are provided merely as examples and are not intended to limit the actual scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Similarly, where a method or sequence is described, the described method is not intended to be limited to only those steps described herein. Rather, additional steps or processes may be added to the method at any point during the method sequence without departing from the scope of the invention. Further, unless expressly stated herein, the methodology of the present disclosure may be conducted in various orders or sequences without departing from the essence of the present disclosure. Finally, the exemplary embodiments presented below may be combined in any combination of ways, i.e., any element or method step from one exemplary embodiment may be used in any other exemplary embodiment, without departing from the scope of the disclosure.

Furthermore, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Further, in the following discussion and in the claims, the terms “including” and “comprising” are used in an open-ended fashion, and thus should be interpreted to mean “including, but not limited to”. All numerical values in this disclosure may be exact or approximate values unless otherwise specifically stated, and as such each numerical value stated in the description should be interpreted to be “about” the recited value. Accordingly, various embodiments of the disclosure may deviate from the numbers, values, and ranges disclosed herein without departing from the intended scope.

The present disclosure generally provides a bolt on method and apparatus for remotely controlling electrical equipment, and more particularly, the apparatus and method of the present disclosure is particularly useful for lessors of restaurant equipment such as ice machines, frozen drink machines, frozen yogurt machines, etc. The apparatus and method of the present disclosure allows an owner or lessor of equipment to remotely turn off or otherwise disable any electrical

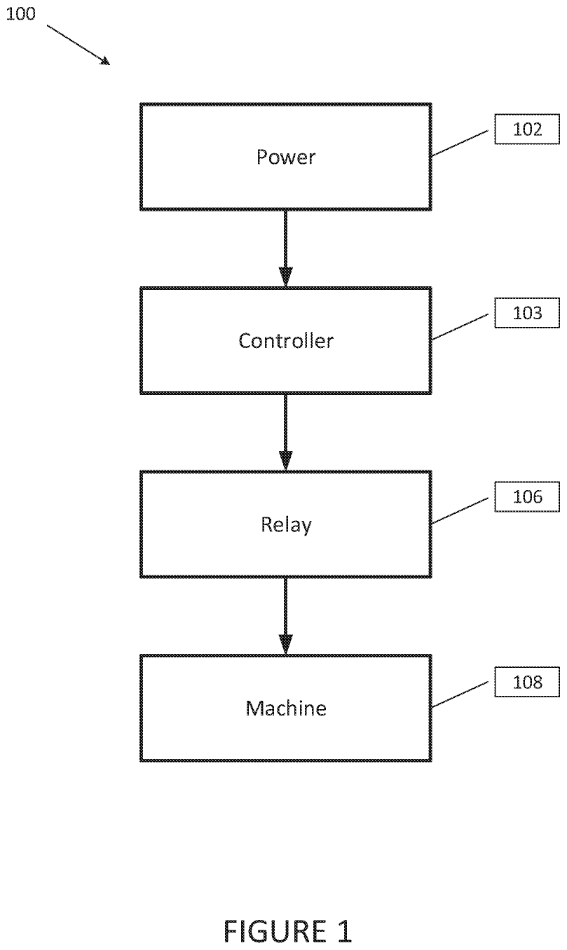

FIG. 1 illustrates a high-level schematic of an exemplary machine control system 100 of the present disclosure. The machine control system 100 generally includes and receives power from a power supply 102. The power supply 102 may typically be, for example, the incoming power (typically called wall or plug power) to a machine, wherein the incoming power is connected to the machine control system 100 generally inside the machine being controlled. The power supply 100 connects to the controller 104 which generally includes a microprocessor-based control system configured to receive various inputs and generate outputs based upon predetermined algorithms embedded in the controller 104 or memory attached thereto. The controller 104 may include one or more input terminals configured to receive controls, outputs from sensors, and other control related inputs. The controller 104 may also include one or more output terminals that may in electrical communication with electrical or other devices on the machine. For example, one of the output terminals of the controller 104 may electrically connect to one or more electrical relays 106, as shown in FIG. 1. The electrical relays 106 operate to turn electrical power on or off to specific electrical components connected thereto, such as the main electrical power to a machine or piece of equipment shown as 108 in FIG. 1.

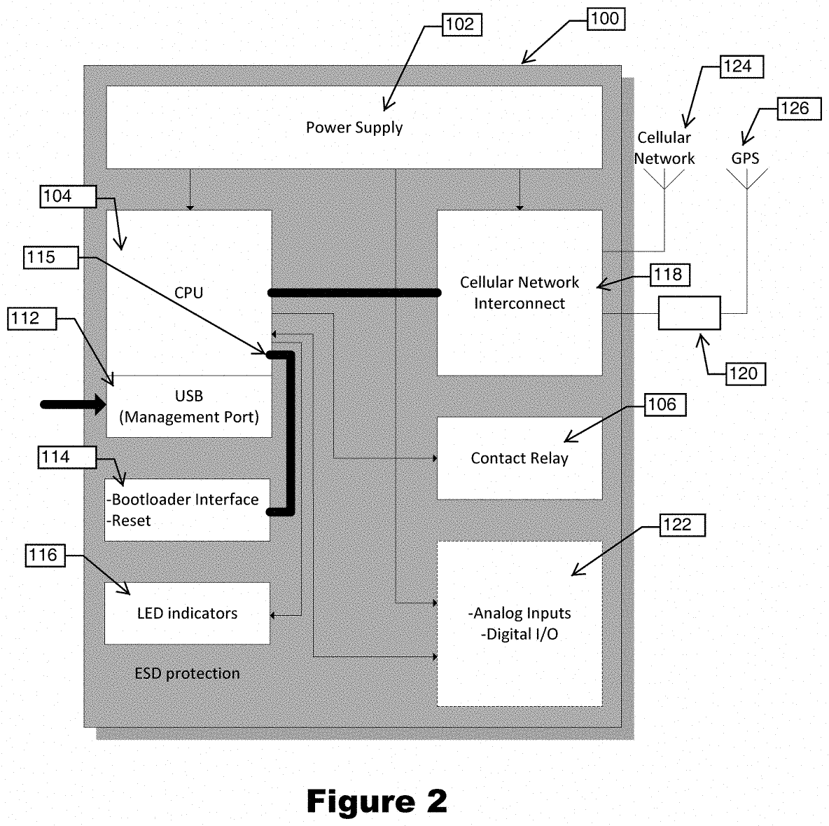

FIG. 2 illustrates a schematic view of a more detailed embodiment of an exemplary control system 100 of the present disclosure. The power supply 102 represents the power input connection or power input module for the control system 100. The power supply 102 is electrically connected to a central processing unit (CPU) 110, which may be a microprocessor-based controller. The CPU 110 receives input from a plurality of devices both onboard and offboard the control system 100, such as receiving inputs from sensors, dedicated analog or digital inputs, computer memory modules, electronic interfaces, communication devices, analog or digital inputs, and any other device known to be electrically connected to or otherwise supply inputs or data to a CPU. At a high level, CPU 110 maintains all digital house-keeping operations while the unit is powered on and services a management port 112 that may be used for troubleshooting, debugging, programming, adjustments, or other functions typically related to a CPU. The CPU 110 is electrically connected to a boot loader interface 114. The boot loader interface 114 generally includes a memory module (not shown) that contains code that is executed by the CPU 110 before or in facilitating the spin up of the operating system that essentially is the core of the CPU's operational functionality. A boot loader 114 may be configured with multiple options for initiating the operating system code on the CPU 110, as well as having several embedded commands that may be used for debugging or modifying the core functionality of the CPU 110. The controller 100 and/or CPU 110 may include an onboard battery to supply power to the system 100 or to facilitate memory or state retention.

The CPU 110 also contains one or more output terminals that may be in communication with various electrical devices, status indicators, etc. One example of an electrical device connection to the outputs of the CPU 110 is LED indicators 116 illustrated in FIG. 2. Other electrical devices, such as an audible alarm or any other electrical device, may also be in communication with the output terminals. The status indicators 116 may illustrate parameters such as system power being on, system operating normally, system in an error mode, system being in an equipment disable mode, system communicating via one or more of the external interfaces such as through a cellular network, system acquiring or has acquired a \Ni-Fi signal, as well as various other status indicators that may be helpful in a control system 100 of this type.

The CPU 110 is also in bidirectional communication with a network interconnect module configured to communicate with a remotely located control station that may provide commands or instructions for the operation of the control system 100. The network interconnect module may be cellular based, pager based, WIFI based, internet based, network based, optical communication based, radio frequency based, or based on any other communication protocol that allows for signal or data transmission across a relatively long distance (generally 5 miles or more). One example of a network interconnect module that may be implemented into the control system 100 of the present disclosure may be a cellular network interconnect module 118. The cellular module 118 may be in communication with a cellular network antenna 124 and be configured to send and receive cellular signals on a plurality of cellular-type networks, such traditional analog, Global System for Mobile Communications (GSM), General Packet Radio Service (GPRS), cdma one, CDMA2000, Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/TDMA), and Integrated Digital Enhanced Network (iDEN). One exemplary cellular network interconnect module 118 that may be implemented into the apparatus of the present disclosure is the ReFLEX 25 or 50 CreataLink chip sold by Motorola Wireless Products. The ReFLEX chips offer two-way wireless messaging through a low cost two-way transceiver that typically operates on a cost-effective pager-type network.

The CPU 110 may also be in electrical communication with a global positioning system module 120 that is configured to receive signals from 2 or more satellites via a GPS antenna 126 and use the received signals to determine the location of the control system 100. The GPS module 120 may communicate the determine positioned back to the CPU 110, which may then use the information in processing decisions/tasks for system controller 100. For example, the system 100 may transmit the GPS determined location to a remote device or monitor through the cellular interconnect module 118 or any other suitable communication device or method. The system 100 may also execute processing instructions based on the location determination to, for example, turn off the electrical machine due to the unauthorized movement of the machine that was determined by the GPS location via comparison to a previous location or range of locations set by the user/owner of the machine or system 100.

The CPU 110 is also in electrical communication with one or more contact or power relays 106. The power relays 106 generally include electrically actuated switches that are activated or deactivated by a control signal received from the CPU 110. Therefore, in operation the power relay 106 may be positioned in the electrical supply circuit for the machine being controlled. Thus, the power relay 106 may be operated to close a circuit and supply electrical power to selected components or parts of the machine. Similarly, the power relay 106 may be selectively opened by a signal from the CPU 110 to discontinue supply of electrical power to components or parts of the machine being controlled. The operation of opening or closing the power relay 106 is controlled by an output of the CPU 110 that is received by the power relay 106. The power relay 106 may be configured to be in a normally open or a normally closed state, depending on user or situational preferences, and the normal state may be changed by the CPU 110 by sending a control signal to the power relay 106 that is configured to change the state (open or closed) of the power relay 106.

The CPU 110 may also be in bidirectional communication with analog/digital input/output module 122. The input output (I/O) module 122 is generally configured to be an interface with devices outside of the control system 100 that allows the CPU 110 to communicate with various external devices to control devices or receive inputs therefrom that may be used by the CPU 110 to generate other outputs or otherwise process information or data. Communication with external devices may, for example, be through receiving or sending electrical signals to/from the 10 module 122. Examples of receiving signals in the 10 module 122 include signals from sensors such as temperature sensors, electrical signals, proximity sensors, rotation sensors, level sensors, flow sensors, shock sensors, timers, weight sensors, and/or any other sensor that may generate an electrical signal representative of a measured parameter. Examples of the 10 module 122 sending signals include sending control signals in the form of high or low voltage signals that may be used to control electronic devices, sending an electrical signal to turn an electrical relay on or off, etc. The 10 module 122 may further be configured to electrically or optically communicate with other computer processor-type devices by sending and receiving data communications, data packets, instructions, acknowledgments, etc.

In operation, the control system 100 may be installed on a piece of electrical equipment, such as a commercial ice machine, a frozen drink machine, a soft serve ice cream machine, or any other electrical device. The control system 100, when installed may be set up so that the power relay 106 is positioned in the main electrical supply line for the equipment being controlled. As such, when the power relay 106 is closed, electrical power will be supplied to the machine being controlled. Conversely, when the power relay 106 is opened, then power to the machine being controlled will be terminated and the machine will stop operating. Similarly, the power relay 106 may be in electrical communication with or supply power to various discrete components of the machine being controlled. For example, on a commercial ice machine the power relay 106 may be in communication with any one of a number of components that are critical to the operation of the ice machine, such as the cooling compressor or a water supply flow solenoid valve. The user or owner of the equipment may select which electrical components are to be disabled during the configuration or installation of the system 100. For example, on an ice cream machine, the power relay 106 may be connected to the drive motor of the machine to stop power thereto without turning off the cooling system of the machine and causing spoilage of the ice cream dairy product.

Once the control system 100 is installed on the piece of equipment, the equipment may be sold, leased, or otherwise positioned at the location of use. The equipment will operate normally and without any interference or control by the control system 100, unless a signal is received by control system 100 instructing the control system 100 to change state. For example, the power relay 106 may be configured to be in a closed position so that power is supplied to the equipment being used in a normal fashion. When the equipment lessor misses or is late on a lease payment, then the lessor of the of equipment may send a control signal to the control system 100 on the machine that is late for payment instructing the control system 100 to change state. More particularly, the control system 100 on the machine at issue may be in a normal operation state and the signal received from the lessor may instruct the control system 100 to go into a shutdown or lockout state, whereby the power relay 106 opens the electrical connection to the main power supply to the machine so that the machine no longer receives electrical power. The open connection of the article power supply disables the machine from operation, as there is no electrical power being supplied to the operating components of the machine.

Similarly, the same piece of equipment may be remotely turned back on via transmission of a change state instruction to the control system 100, whereby the change state instruction causes the CPU 110 to activate the power relay 106 so that electrical power is again supplied to the equipment being controlled. Thus, in the example of a leased piece of restaurant equipment noted above, the lessor may disable the piece of equipment when the lessee fails to make a payment, and then the lessor may re-enable the equipment via sending a signal to the equipment through the control system 100 once the lessee has made the required payment along with any surcharge for reconnection, late payment, etc.

Further detailing the operation of the control system 100, when the control system 100 is initially powered up, the CPU 110 may initialize all peripherals internally such as UART, 120, GPIO, FLASH, etc. The CPU may then initialize the network interconnect module 118 to connect to a desired network (Web, IoT, Cloud, cellular, etc.). Reading non-volatile memory that is generally onboard with the CPU 110 or electrically connected thereto for system settings and previous states may also be accomplished while the peripherals are being initialized. The previous state of the equipment, such as enabled for operation or disabled from operation, may be read from the memory and once the previous state has been read, output control messages may be sent, for example, to the power relays 106 to appropriately set the current state of the machine being controlled (based on the last known state). Further, the initialization process may include the CPU 110 sending update messages, such as current state, location, fault or error messages, tamper messages, etc., to a remote monitoring site. One of the final steps the CPU 110 may do in the initialization process is check the network for pending incoming control messages that determine the current or desired state of the equipment being controlled. The CPU 110 processes any incoming new control messages and updates the output control messages sent to the peripherals or the power relays 106 accordingly. As noted above, if no new control message is received, the control system 100 will default to the last known state saved in the onboard memory. In one embodiment, the control system 100 may be configured to automatically disable the power relay 106 if a new control message is not received in a specific time period to prevent users from bypassing the communication capability of the system, which would in effect disable the remote shut of capability of the control system 100.

After initialization, the CPU may conduct a plurality of routine house-keeping tasks. Some of the house-keeping tasks include but are not limited to acquiring GPS coordinates, sending update messages to remote monitoring stations, updating non-volatile memory settings, verifying non-volatile memory settings, sending system status information over the management port 112, and authenticating management port 112 usage via password.

The CPU 110 may also be configured to send and receive messages from a master control or monitoring system, which may, for example, be a control related website and the accompanying back end processing devices associated therewith. For example, a control website or computer system may be created to monitor a plurality of control systems 100. The CPU 110 for each control system 100 may be configured to contact the control website or control computer system when initialized and/or at predetermined time intervals. The control website or computer system may provide state instructions to the system controller 100 to determine the operational state of each machine connected to a control system 100.

In another embodiment of the disclosure, the control system 100 may be remotely controlled by SMS type messages. The network interconnect module 118 may be configured to send and receive text-type messages that contain instructions that the control system 100 may interpret to change the state of the control system 100. For example, a lessor of equipment may send a text message to the control system 100 installed in a leased piece of equipment, whereby the text message includes an instruction to enable or disable the piece of equipment via the above noted power relay 106. The text message may include a plurality of fields or data bits, including for example, security or password information that the control system 100 may use to verify that the signal or message being received is from an authorized sender. The control system 100 may further be configured to change state only upon receiving a text message from a specific mobile device or phone number or group of numbers, thus preventing unauthorized parties from changing the state of equipment without permission. The format of the message may vary from user to user and the data fields of the message may be configured to represent various control functions that may be interpreted by the control system 100. As an example, the control system 100 may include any number of power relays 106, and the control system 100 may energize specific power relays 106 to activate selected functionalities. Exemplary functionalities may include indicator lights, selected machine functions, audible signals, or permanently disabling functionality that may be used in catastrophic situations.

In various embodiments of the present disclosure, the cellular interconnect module 118 may comprise various types of communication devices. For example, the cellular interconnect module 118 may be configured to communicate via the cellular protocol noted above, by typical WIFI signals, by radio frequency signals, by WLAN or LAN communications, by typical internet connections, and/or by any other communication protocol desired.

In at least one embodiment of the disclosure the interconnect module 118 may be configured as a WIFI communicator and the control system 100 may be assigned a specific IP address and that address may be remotely monitored to determine and change the status of various aspects of the equipment. In embodiments where the interconnect module 118 utilizes other communication protocols, the controller 100 may use unidirectional or bidirectional communication through any number of protocols to communicate with a master control system that is configured to determine what state each of controller 100 should be in.

The master control system may be a web-based system supported by various processing systems. The web-based system may include a plurality of selectable fields that correspond to functionalities controlled by the controller 100 on specific pieces of equipment. The master control system may be configured to allow authorized users to readily change various states of functionalities on the web-based system by clicking or selecting to enable/disable functionalities for each machine having a control system 100 thereon. The selected functionalities may then be correlated to specific power relays 106 on specific controllers 100 and a control message generated that corresponds to the selected functionalities. The control message may then be sent to the appropriate controller 100 for execution or to otherwise change the state of specific power relays 106 that correspond to specific machine functionalities that have been selected on the master control system.

In various embodiments of the present disclosure an instruction message is sent to the controller 100 that tells the controller to change the state of one or more power relays 106. These instruction messages may be in one of several formats, including but not limited to a text message, a specific bit length data packet, an audible tone, an asci file, or any other format that allows for data transmission from a master control station to a remotely positioned machine having a controller 100 thereon. The data, regardless of format, may be formatted to have various fields, including for example, one or more fields that identify specific power relays 106 that are to change state, the specific state each power relay is to be changed to, and security or other data validation fields that allow the controller 100 to confirm that the instruction message is authentic and/or from an authorized sender. Other fields in the instruction message sent to controller 100 may be used to set up the controller 100 for upcoming events, such as requiring the user or service tech to perform an activity, such as a preventative maintenance task. In this example the controller 100 may be configured to indicate to the user that a preventative maintenance task is due and require the user or service tech of the machine to conduct the required task or the machine will be remotely disabled until the service task is completed. The instruction message sent to the controller 100 may also instruct the controller 100 to execute specific tasks such as sending information back to the master control station. Information that could be sent by the controller 100 may include, for example, the location of the machine, metrics on the operation of the machine (hours of use, alarms or errors, etc.), temperatures, pressures, speeds, and other parameters sensed by various sensors onboard the machine.

The GPS module 126 may operate to receive satellite signals to determine the location of the machine that the controller 100 is installed on. However, GPS is not always a reliable tool for determining location when the equipment will most often be positioned indoors and outside of the view of satellite communication. The system 100 of the present disclosure may use various other methods for determining the location of the machine within which the system 100 is installed. For example, the system 100 may determine its location by triangulation of cellular or radio frequency signals, by an IP address of a WIFI network, or any other method used to determine the location of mobile device such as a cellular phone, computer, tablet, or other electronic device. The system 100 may be configured to send location information on the system 100 or the machine associated therewith to a master controller at predetermined time periods, upon each startup of the system 100, or at other user defined intervals. Each of these methods for determining location may utilize the GPS module 126 and/or other modules in the system 100.

In an embodiment of the present disclosure, the controller 100 and specifically the CPU 110 may be configured to shut down a machine upon certain predetermined or sensed criteria. For example, The CPU 110 may be configured to open all power relays if the system 100 has been tampered with. Similarly, the controller 100 or the CPU 110 may be configured to open one or more power relays 106 if the last state of the controller 100 is unknown. Further, the controller 100 may be configured to send a message to the master controller if the controller enters a state where on powerup the last state of the machine is unknown. In yet another embodiment, the controller 100 may be configured to open one or more power relays 106 if the controller has not received a status update or control message from the master controller in a predetermined time period. This embodiment helps lessors with machine theft and tampering related to the controller 100.

In another embodiment of the present disclosure, the controller 100 may monitor the location of the machine being controlled and compare the location to previous locations. For example, the controller 100 compare the current location upon power up to the last known location upon a power up. If the locations vary by more than a preset distance, 500 feet, for example, then the controller 100 may shut down the machine (open a power relay 106). This feature may be used to ensure lessors that the machine leased remains in the agreed location and substantially reduces asset location challenges.

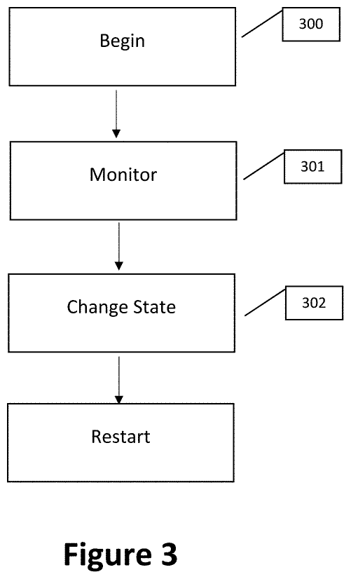

FIG. 3 is a flowchart illustrating an exemplary method of the disclosure. The exemplary method of the present disclosure begins at step 300 in FIG. 3. During this step the control system 100 of the present disclosure is generally installed onto a piece of electrically powered equipment. The control system 100 is installed such that it receives its operating power from the main power supply for the piece of electrical equipment, which is typically the power cord coming into the machine from the wall outlet to which the machine is plugged into. The control system 100 will therefore receive power any time the electrical machine is plugged in. The power relay 106 may then be installed in the main power source line coming into the machine in a serial manner between the power source and the electrical equipment. For example, in a typical installation the electrical power coming into the electrical machine must flow through the power relay 106 before it is supplied to the components of the electrical machine. However, the control system 100 may generally be electrically connected to the electrical power supply independent of the power relay 106, such that the control system 100 will receive electrical power from the power supply regardless of the open/closed state of the power relay 106.

The next step illustrated in the methodology of FIG. 3 is step 301, where the control system 100 monitors for incoming control or command messages. When the control system 100 receives a command message, the control system 100 may execute a control or state change of the various power relays 106 connected thereto in accordance with the command or instruction contained in the message. For example, the control system 100 may receive a control or command message that indicates that the electrical machine within which the control system 100 is installed is to be shut down. In this situation, the control system 100 would send a state change message to a power relay 106 that is supplying or communicating electrical power to the electrical machine. When the power relay 106 opens and terminates electrical power going therethrough, then the electrical machine will no longer be supplied power and will therefore be shut down. The control system 100 may execute a plurality of measures to validate the controller command messages coming into the control system 100. For example, the control system 100 may receive control or command messages via text message, and the text message received may be validated by confirming the source phone number of the origin text message. If the controller command message is received via a data packet through a Wi-Fi connection, for example, then the data packet may be validated against security parameters such as a predetermined number of bit correspondences (a security bit string embedded in the packet). Similar controller command message validation schemes may be implemented for various signal transmission methodologies.

The control system 100 may be configured to monitor for control or command messages sent from a remote location at various times or upon execution of various events. For example, the control system 100 may be configured to check for control or command messages every time the electrical machine is powered up. Alternatively, the control system 100 may be configured to check for control or command messages sent from a remote location at predetermined time intervals, such as once every day or once every week, the duration may be determined or set by the owner of the equipment and control system 100. The control or command messages may be sent to the control system 100 through any of a number of signal transmission methods, including cellular signals, pager signals, text messages, radio frequency signals, network signals, optical signals, and/or any other known method for sending data signals.

Once the control system 100 receives a valid controller command message, the next step illustrated at 302 is for the control system 100 to execute the change of state of one or more power relays 106. The change of state occurs when the control system 100, or more particularly the CPU 110, sends an electrical signal to one or more of the power relays 106, whereby the electrical signal is configured to change the state of the power relay 106 from open to closed or closed to open, as desired. This change of state either terminates electrical power or reestablishes electrical power to the electrical component connected to the power relay 106. The control or command message may be configured to change a plurality of states of a plurality of different or discrete power relays 106 in accordance with the remote shut off system user's desire.

Once the change state instruction and operation has been received and executed at step 302, the method may return back to step 301 where the control system 100 continues monitoring for the next incoming control message. The method may then end at step 303.

One embodiment of the invention is implemented as a program product for use with a computer system such as, for example, the microprocessor based controller 104 shown in FIGS. 1 & 2 and described above. The program(s) of the program product defines functions of the embodiments (including the methods described herein) and can be contained on a variety of computer-readable media. In general, the routines or processes executed to implement the methods or processes of the disclosure may be part of an operating system or a specific application, component, program, module, object, or sequence of instructions. The computer program of the present disclosure typically is comprised of a multitude of instructions that will be translated by the native processor into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Aspects presented in this disclosure may be embodied as a system, method or computer program product. Accordingly, aspects disclosed herein may take the form of an entirely hardware embodiment, an entirely software embodiment (including firmware, resident software, micro-code, etc.) or an embodiment combining software and hardware aspects that may all generally be referred to herein as a “circuit,” “module” or “system.” A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing. Computer program code for carrying out operations for aspects disclosed herein may be written in any combination of one or more programming languages. The program code may execute entirely on the processor, partly on the processor, as a stand-alone software package, partly on the processor of the user and partly on a remote computer, or entirely on the remote computer or server. In the latter scenario, the remote computer may be connected to the computer of the user via any type of network, including a local area network (LAN) or a wide area network (WAN), or the connection may be made to an external computer (for example, through the Internet using an Internet Service Provider).

Embodiments disclosed herein may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications (e.g., enterprise system 102) or related data available in the cloud. For example, the enterprise system 102 could execute on one or more computing systems in the cloud and process transactions involving arbitrarily large data structures.

Embodiments of the disclosure provide a system for remotely controlling power relays in a food service machine, wherein the system may include an electronic controller in communication with a source of electrical power, the electronic controller being configured to generate an electrical control signal in response to the electronic controller receiving a cellular text message state control signal from a remote device, the electronic controller may include a microprocessor-based processing unit, a nonvolatile memory device in bidirectional electrical communication with the processing unit, and a cellular communication device in bidirectional communication with the processing unit. The system may further include an electrical contact relay in electrical communication with the source of electrical power and one or more components of a machine being controlled, the electrical contact relay including an electromagnetic switch having an open state and a closed state, the closed state being where the switch conducts electrical power, a control input to receive the state control signal to control the electrical contact relay between the open state and the closed state, and an electromagnetic coil in communication with the control input, the coil being configured to create magnet when energized by an electrical signal supplied through the control input tat actuates the electromagnetic switch to the closed state.

The system may further include the processing unit being configured to generate the state control signal communicated to the control input of the electrical contact relay, the state control signal operating to change a state of the electrical contact relay. The system may further include changing the state of the electrical contact relay comprising changing from an electrically open state to an electrically closed state or changing from an electrically closed state to an electrically open state. The system may further include the processor unit generating the control signal in response to the cellular text message after the cellular text message is validated as being authentic. The system may further include the cellular text message comprising an SMS text message, a pager message, or a data packet transmitted through a cellular network. The system may further include the message having a validator field to confirm that the message was sent from an authorized master control.

Embodiments of the disclosure may further provide a system for remotely controlling electrical power supplied to a piece of electrically operated restaurant equipment that may include an electronic controller in communication with a source of electrical power, the electronic controller including a processor, a wireless communication device connected to the processor, and a selectively actuated electrical switch in communication with and controlled by the processor. The processor may receive a control instruction via a cellular text message from a remote master controller through the wireless communication device, the control instruction being processed by the processing module to confirm the text message was sent from an authorized master controller by comparing a validator field in the text message to a stored validator field, and if the text message is validated, then generating a change of state instruction that is communicated to the selectively actuated electrical switch, the selectively actuated electrical switch then opens or closes an electrical flow path corresponding to the change of state instruction.

The system may further include the processing module validating the authenticity of the control instructions before generating a change of state instruction by comparing a validator field that includes a predetermined data string that is saved in a memory onboard the electrically operated restaurant equipment that must match the validator field in the text message to validate the text message. The system may further include comparing a numerical or data sequence contained in the received control instructions to a numerical or data sequence stored in a memory module in communication with the processing module. The system may further include the control instructions being received as a text message from the remote master controller and wherein validating comprises comparing an origin phone number for the text message with a stored origin phone number saved in the memory module. Also the processing module may receive control instructions upon power up of the processing module or at predetermined intervals, and a GPS module in communication with the processing module may be included and configured to provide geographic location information to the processing module. The wireless communication module may include a cellular communication interface configured to send and receive cellular-type signals and the location of the system may be determined by triangulation of cellular-type signals between the communication module and at least two cellular towers or antennas.

Embodiments of the disclosure may provide a method for remotely shutting down electrical restaurant equipment that may include receiving a cellular SMS-type text control message in a communication interface of a microprocessor-based control system onboard the electrical restaurant equipment and in electrical communication with the electrical restaurant equipment; validating the cellular SMS-type text control message by comparing a text or numerical sequence encapsulated within the received cellular SMS-type text control message to a known validation text or numerical sequence stored onboard the electrical restaurant equipment in a nonvolatile memory in communication with the microprocessor-based processor; after validating, processing the cellular SMS-type text control message in the control system to generate a change state instruction: and sending the change in state instruction to a power relay or selectively actuated electrical switch in communication with a power source of the electrical restaurant equipment, the change in state instruction causing the power relay or selectively actuated electrical switch to open circuit so that electrical power is no longer provided to the electrical restaurant equipment.

The method may further include the cellular SMS-type text control message being an SMS text message received by cellular communication interface in the control system. Also, the validating may include comparing an origin phone number for the cellular SMS-type text control message to a stored valid phone number contained in a non-volatile memory in communication with the processor module of the control system. The control system may automatically check for incoming or pending cellular SMS-type text control messages upon startup and at predetermined intervals.

In the above description reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim.

While the foregoing is directed to embodiments presented in this disclosure, other and further embodiments may be devised without departing from the basic scope of contemplated embodiments, and the scope thereof is determined by the claims that follow.

1. A system for remotely controlling power relays in a food service machine, the system comprising:
an electronic controller in communication with a source of electrical power, the electronic controller being configured to generate an electrical control signal in response to the electronic controller receiving a cellular text message that includes a state control signal from a remote device, the electrical control signal being different from the state control signal, and the electronic controller comprising:
a microprocessor-based processing unit;
a nonvolatile memory device in bidirectional electrical communication with the processing unit;
a cellular communication device in bidirectional communication with the processing unit; and
an electrical contact relay in electrical communication with the source of electrical power and one or more components of the food service machine being controlled, the electrical contact relay comprising:
an electromagnetic switch having an open state and a closed state, the closed state being where the switch conducts electrical power;
a control input to receive the electrical control signal to control the electrical contact relay between the open state and the closed state; and
an electromagnetic coil in communication with the control input, the coil being configured to create magnet when energized by an electrical signal supplied through the control input that actuates the electromagnetic switch to the closed state.

2. The system of claim 1, wherein the processing unit is configured to generate the electrical control signal communicated to the control input of the electrical contact relay based on processing of the state control signal, the electrical control signal to change a state of the electrical contact relay.

3. The system of claim 2, wherein changing the state of the electrical contact relay comprises changing from an electrically open state to an electrically closed state or changing from an electrically closed state to an electrically open state.

4. The system of claim 3, wherein the processing unit generates the electrical control signal in response to the state control signal after the state control signal is validated as being authentic.

5. The system of claim 4, wherein the cellular text message comprises an SMS text message, a pager message, or a data packet transmitted through a cellular network.

6. The system of claim 1, wherein the cellular text message includes a validator field to confirm that the message was sent from an authorized master control using a comparison with a stored validator field.

7. A system for remotely controlling electrical power supplied to a piece of electrically operated restaurant equipment comprising:
an electronic controller in communication with a source of electrical power, the electronic controller including:
a processing module,
a wireless communication device connected to the processing module, and
a selectively actuated electrical switch in communication with and controlled by the processing module,
the processing module receiving a control instruction via a cellular text message from a remote master controller through the wireless communication device, the control instruction being processed by the processing module to confirm the text message was sent from an authorized master controller by comparing a validator field in the text message to a stored validator field, and if the text message is validated, then generating a change of state instruction that is different from the cellular text message and is communicated to the selectively actuated electrical switch, the selectively actuated electrical switch then opens or closes an electrical flow path corresponding to the change of state instruction.

8. The system of claim 7, wherein the processing module validates an authenticity of the control instructions before generating the change of state instruction by comparing the validator field that includes a predetermined data string that is saved in a memory onboard the electrically operated restaurant equipment that matches the validator field in the text message to validate the text message.

9. The system of claim 8, wherein validating the authenticity comprises comparing a numerical or data sequence contained in the received control instructions to a numerical or data sequence stored in a memory module in communication with the processing module.

10. The system of claim 9, wherein the control instructions are received as a text message from the remote master controller and wherein validating comprises comparing an origin phone number for the text message with a stored origin phone number saved in the memory module.

11. The system of claim 10, wherein the processing module receives control instructions upon power up of the processing module or at predetermined intervals.

12. The system of claim 11, further comprising a GPS module in communication with the processing module and configured to provide geographic location information to the processing module.

13. The system of claim 11, wherein the wireless communication module comprises a cellular communication interface configured to send and receive cellular-type signals.

14. The system of claim 13, wherein the location of the system is determined by triangulation of cellular-type signals between the communication module and at least two cellular towers or antennas.

15. A method for remotely shutting down an electrical restaurant equipment, the method comprising:
receiving a cellular SMS-type text control message in a communication interface of a microprocessor-based control system onboard the electrical restaurant equipment and in electrical communication with the electrical restaurant equipment;
validating the cellular SMS-type text control message, using the microprocessor-based control system, by comparing a text or numerical sequence encapsulated within the received cellular SMS-type text control message to a known validation text or numerical sequence stored in a nonvolatile memory in communication with the microprocessor-based processor;
after validating, processing the cellular SMS-type text control message in the microprocessor-based control system to generate a change state instruction, the change state instruction being different from the cellular SMS-type text control message; and
sending the change in state instruction to a power relay or selectively actuated electrical switch in communication with a power source of the electrical restaurant equipment, the change in state instruction causing the power relay or selectively actuated electrical switch to open circuit so that electrical power is no longer provided to the electrical restaurant equipment.

16. The method of claim 15, wherein the cellular SMS-type text control message comprises an SMS text message received by cellular communication interface in the control system.

17. The method of claim 15, wherein validating comprises comparing an origin phone number for the cellular SMS-type text control message to a stored valid phone number contained in the non-volatile memory in communication with the processor module of the control system.

18. The method of claim 16, wherein the control system automatically checks for incoming or pending cellular SMS-type text control messages upon startup and at predetermined intervals.

19. The system of claim 6, wherein the validator field of the cellular text message is an originating phone number.

20. The system of claim 7, wherein the validator field of the cellular text message is an originating phone number.
